(19) United States
(12) Patent Application Publication
(10) Pub. No.: US 2006/0233204 A1
(43) Pub. Date: Oct. 19, 2006

(54) Redundant I/O interface management

(76) Inventors: Ken G. Pomaranski, Roseville, CA (US); Andrew H. Barr, Roseville, CA (US); Dale J. Shidla, Roseville, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/109,309

(22) Filed: Apr. 19, 2005

(51) Int. Cl. G06F 3/00; H04J 3/04

(52) U.S. Cl. 370/535; 710/8

(57) ABSTRACT

A computer system has redundant I/O interface modules for managing communications between an incorporating computer system and an external system such as a network or multi-port disk array. A redundant I/O interface manager directs communications through one of the redundant I/O interface modules, and switches the communications through the other, e.g., when a failure of the first I/O interface module is detected or predicted. The redundant I/O interface module appears to the operating system of the incorporating system as the first I/O interface module would so the switching is effectively invisible to the operating system.

### BACKGROUND OF THE INVENTION

The present invention relates to computers and, more particularly, to I/O (“input/output) subsystems for computers. In this specification, related art labeled “prior art” is admitted prior art; related art not labeled “prior art” is not admitted prior art.

The prevalence of computers in modern society is due in part to adherence to interface standards that allow general-purpose computers to be assembled, maintained, and upgraded using off-the-shelf, often third-party, components. High-availability computers used in applications where downtime due to a defective component is very costly have not benefited to the same extent that general-purpose computers have from standards as components typically must be specially designed to meet high-availability criteria. For example, some components, such as network and disk-array I/O interface cards can be arranged in redundant groups so that if one fails, another can take over without significantly interrupting operation. The special design often involves not only special hardware designed for redundant operation, but also special software, e.g., operating systems and drivers designed to manage redundant components. These, in turn, require high amounts of engineering design resources and extended design and development schedules (which are problematic in a rapidly evolving market).

### SUMMARY OF THE INVENTION

The present invention, as defined in the claims, provides a redundant I/O interface manager for managing a redundant arrangement of off-the-shelf I/O interface modules (e.g., I/O interface cards) to multipath targets, e.g., networks and multipath disk arrays, while making it appear to the I/O interface card driver that a single I/O interface card is present. The invention obviates the need for special drivers for the I/O interface cards: stock drivers not designed for redundant operation can be used. Since off-the-shelf I/O interface cards and drivers can be used, significant cost saving can be achieved in manufacturing, maintenance, and upgrading. In addition, the invention reduces the resources required to design a highly reliable/available computer, provides faster development times, and thus achieves more timely release schedules. These and other features and advantages of the invention are apparent from the description below with reference to the following drawings.

### BRIEF DESCRIPTION OF THE DRAWINGS

FIG. 1 is a schematic block diagram of one of many possible computer systems provided for by the present invention.

FIG. 2 is a flow chart of one of many methods provided for by the present invention.

### DETAILED DESCRIPTION

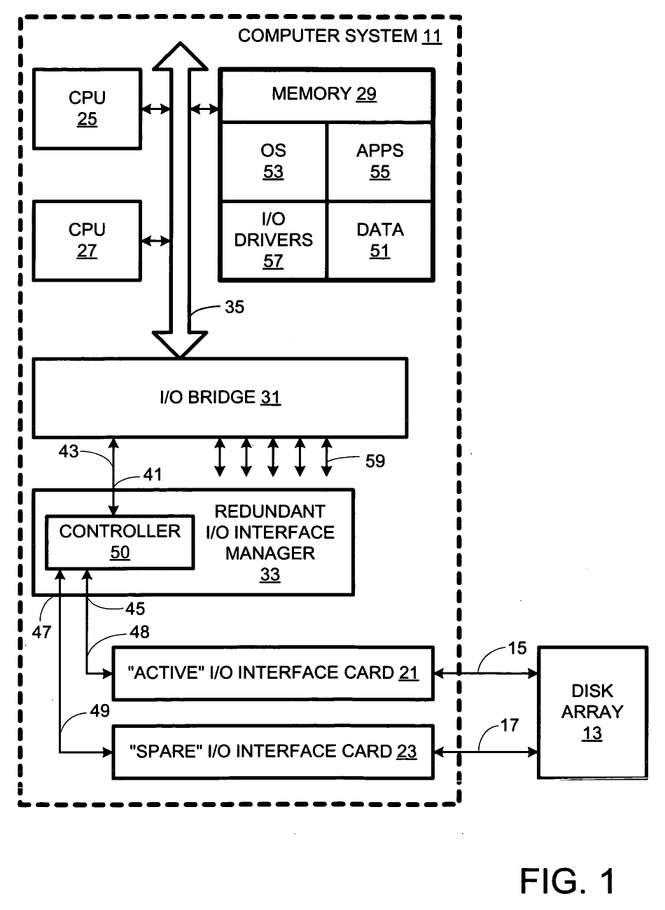

A computing system AP1 in accordance with the present invention is shown in FIG. 1 comprising a computer 11 and a disk array 13. Disk array 13 provides for two independent connections at ports 15 and 17. In typical arrangements, the two connections are to two different computers. In the present case, the two connections are to two different disk-array I/O interface cards 21 and 23 of computer system 11. In other embodiments, the target is a network and the I/O interface cards are network I/O interface cards. More generally, the I/O interface cards can connect to other types of devices with two or more available connections.

Computer system 11 comprises processors 25 and 27, memory 29, an input-output (I/O) bridge 31, a redundant I/O interface manager 33, and I/O interface cards 21 and 23, as well as other components. Processors 25 and 27, memory 29, and I/O bridge 31 are communicatively connected via a communication fabric, shown schematically as a bus 35. I/O bridge 31 is coupled to a system port 41 of redundant I/O interface manager 33 via a PCI-bus-interface-to I/O bridge 43. I/O interface cards 21 and 23 are respectively coupled to I/O ports 45 and 47 of redundant I/O interface manager 33 by bus interfaces 48 and 49. In alternative embodiments, I/O communications protocols and technologies other than PCI are used. A controller 50 of redundant I/O interface manager 33 manages the interactions among its ports 41, 45, and 47.

Memory 29 includes both random-access memory and internal hard disks. Memory 29 stores data 51 and programs including an operating system 53, applications 55, and I/O drivers 57. Note that I/O bridge 31 has several connections 59; in FIG. 1 the devices to which the connections are made are not shown, but these can include other I/O devices, some of which are in redundant arrangements, while others are not.

I/O interface cards 21 and 23 are nominally identical in that they are from the same manufacturer and are provided with identical drivers. I/O drivers 57 include just one instance of the driver used for both I/O interface cards 21 and 23. Upon initialization, redundant I/O interface manager 33 selects one of the cards, e.g., card 21 as the “active” card, and the other, e.g., card 23, as the “spare”. Communications with disk array 13 are solely through the presently active card. Redundant I/O interface manager 33 serves as a proxy for I/O interface cards, appearing to operating system 53 as a single I/O interface card. No modification of the driver software is required to support redundant operation.

During normal operation, RIM controller 50 can recognize configuration data based on the transaction ID and the address space being written. RIM controller 50 automatically mirrors configuration data intended for the I/O interface card it appears to be so that it is received by both the active and the spare I/O interface cards. Thus, the spare is thus maintained in the same configuration as the active card. When a switchover occurs, the spare is in the state expected by the driver.

In the event the presently active card falls, RIM controller 50 manages a switchover to the spare card. Communication through the formerly active card is terminated and then activated through the spare. RIM controller 50 manages the switchover in a manner invisible to OS 53 except for a possible timeout during the time it takes to effect the switchover. Typically, in the event of a time out, a communication retry is induced so that no loss of data occurs. A PCI bus error occurs only when both active and spare I/O interface cards fail.

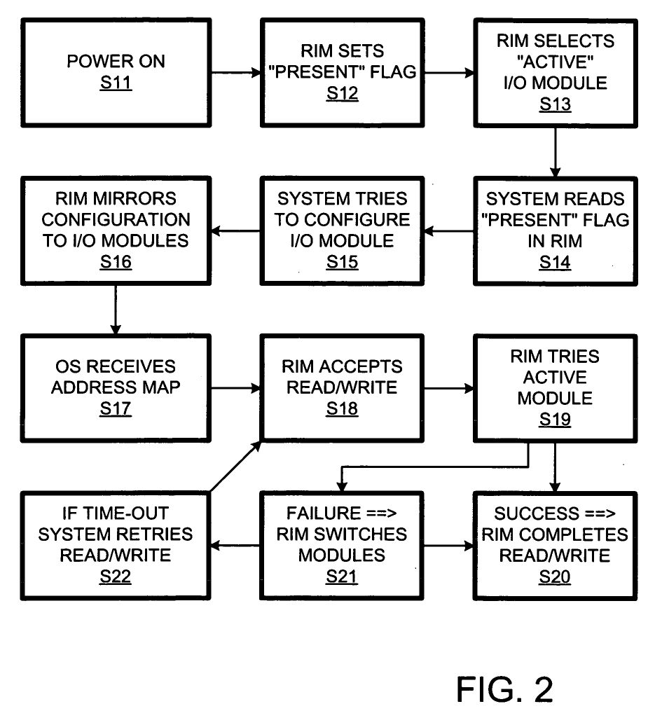

A method M1 of the invention as practiced in the context of network API is flowcharted in FIG. 2. System 11 is powered on at method segment S11. At method segment S12, RIM 33 checks for the presence of I/O interface cards in its two slots and set a “presence” flag if there is at least one I/O interface card present. At method segment S13, assuming two cards are present, RIM 33 selects one of I/O interface cards, e.g., card 21, to be the primary I/O interface card and the other, e.g., card 23, to be the secondary I/O interface card. The primary card is by default “active”, while secondary I/O interface card is by default the “spare”.

At method segment S14, system firmware walks I/O buses looking for I/O interface cards. Instead of reading cards 21 and 23, it reads the presence flag set in RIM 33 serving as I/O interface-card proxy. At method segment S15, assuming the presence flag is set, the system firmware attempts to initialize the “card” it detects. This can involve setting an I/O address, setting mode bits, providing microcode, etc. At method segment S16, RIM 33 mirrors all setup transactions across the two I/O interface cards 21 and 23. At this point, I/O interface cards 21 and 23 have been set up identically. During operation, if operating system 53 sends new configuration data, RIM 33 also mirrors it to both I/O interface cards 21 and 23 so that their configuration states remain coherent. At method segment S17, firmware presents the address map to operating system 53 as it boots up. Again, redundant pair 21 and 23 appears as a single I/O interface card with a single address to operating system 53 and drivers 57.

At method segment S18, during normal operation, RIM 33 accepts read/write operations from operating system 53 via bridge 31. RIM 33 holds the transaction until it is completed. At method segment S19, RIM 33 forwards the operation to the active I/O interface card, e.g., card 21. If the requested transfer involving disk array 13 is successful, RIM 33 completes the read/write operation at method segment 20.

If the transaction is not successful, RIM 33 performs a switchover at method segment S21. If the transaction with disk array 13 is successfully effected through the newly active I/O interface card, e.g., card 23, RIM 33 completes the read/write operation at method segment S20. If instead, the read/write operation times out, from the perspective of operating system 53, method MI would normally return to method segment S18 for a retry. Presumably, the retry would be successful. However, if both cards have failed, the transaction cannot be completed. This case can be handled in the same manner as a failure of a single I/O interface card in a non-redundant configuration.

In method M1, a switchover occurs when a failure of the active card is detected. However, a switchover can occur in other situations as well. For example, a switchover can occur in response to a prediction of a failure, e.g., when RIM 33 detects excessive errors in transactions involving the active card. Also, switchovers can be performed to help balance duty cycles between I/O interface cards. In an alternative embodiment, the redundant I/O interface cards are visible to the operating system, but not to the specific I/O interface card driver; in this alternative embodiment, the OS may force a switch.

The invention provides for systems with any number of processors and any memory architecture. The redundancy can involve two or more I/O interface modules. In some embodiments with arrangements of three or more I/O interface modules, the invention provides for more than one active I/O interface module. While in the illustrated embodiment, only one driver is used for both I/O interface cards, the invention further provides for redundancy management software that can juggle different drivers so that the redundant interface modules need not use identical drivers. While in the illustrated embodiment, the I/O interface modules can be described as “cards”, the invention provides for modules with other form factors. These and other variations upon and modifications to the described embodiment are provided for by the present invention, the scope of which is defined by the following

What is claimed is:

1. A redundant I/O interface manager comprising:
a first connection for connecting to a first I/O module;
a second connection for connecting to a second I/O module;
a system interface for interfacing with an incorporating system so as to appear to an I/O interface module driver of said incorporating system as if it were said first I/O interface module; and
a controller for switching settings for said I/O interface modules so that said first I/O interface module stops communicating with an external system connected to both of said I/O interface modules and so that said second I/O interface module begins communicating with said external system.

2. A redundant I/O interface manager as recited in claim 1 wherein said controller switches said settings in response to a detection of a failure of said first I/O interface module.

3. A redundant I/O interface manager as recited in claim 1 wherein said controller switches said settings in response to a prediction of a failure of said first I/O interface module.

4. A redundant I/O interface manager as recited in claim 1 wherein said controller transmits configuration data from said operation to both said first and second I/O interface modules so that they both undergo the same configuration changes.

5. A redundant I/O interface manager as recited in claim 1 wherein said system interface connects to an I/O bridge chip.

6. A method comprising:
responding to communications from an operating system as a first I/O interface module would and directing communications between and incorporating system and an external system through a first path including said first I/O interface module and a first port of said external system; and
subsequently, while continuing to respond to communications from said operating system as said first I/O interface module would, switching communications from said first path to a second path including a second I/O interface module and a second port of said external system.

7. A method as recited in claim 6 further comprising detecting or predicting a failure of said first I/O interface module, said switching being in response to said detecting or predicting.

8. A method as recited in claim 6 further comprising:
receiving configuration data intended for said first I/O interface module; and
providing copies of said configuration data to both said first I/O interface module and said second I/O interface module so that their configuration states remain coherent.

9. A method as recited in claim 6 wherein said external system is a network.

10. A method as recited in claim 6 wherein said external system is a multi-port disk array.
